(19) United States
(12) Patent Application Publication
(10) Pub. No.: US 2024/0191512 A1
(43) Pub. Date: Jun. 13, 2024

(54) Tile With A Glowing Grout Receiving Feature

(71) Applicant: Tile Media Properties, Inc., Marietta, GA (US)

(72) Inventor: Curt V. Rapp, Atlanta, GA (US)

(73) Assignee: Tile Media Properties, Inc., Marietta, GA (US)

(21) Appl. No.: 18/534,013

(22) Filed: Dec. 8, 2023

Related U.S. Application Data
(60) Provisional application No. 63/386,655, filed on Dec. 8, 2022.

(51) Int. Cl. E04F 13/08; G09F 13/20

(52) U.S. Cl. CPC E04F 13/0871; G09F 13/20

(57) ABSTRACT

A decorative tile with a glowing grout receiving feature is provided. The decorative tile includes a decorative face and the grout receiving feature formed into the decorative tile, wherein the grout receiving feature includes a recess from the decorative face. The decorative tile may include glowing grout disposed within the grout receiving feature.

### CROSS-REFERENCE TO RELATED APPLICATIONS

The subject patent application claims priority to, and all the benefits of, U.S. Provisional Patent Application No. 63/386,655, filed on Dec. 8, 2022, the entire contents of which are incorporated by reference herein.

### INTRODUCTION

The disclosure generally relates to a tile with a glowing grout receiving feature.

Tile is a construction component useful to cover a surface. Tile may cover floors, walls, roofs, a boundary to a pool, surfaces within a bathroom or a kitchen, or other objects. Tiles may be constructed with ceramic materials, porcelain materials, stone materials, metal materials, glass materials, or other similar materials. A tile may be planar, with a decorative planar top side, side edges, and a bottom which may be flat or may include features configured for strength, low weight, and improved adhesion to a mating surface. A tile may be curved, may be formed to make a corner, or may have other complex shapes.

Grout is a cementitious product which may include water, cement, and sand. Grout may be utilized to fill space between tiles. Grout may be applied as a paste or dense fluid, and the grout may solidify after it dries.

### SUMMARY

A system including decorative tile with a glowing grout receiving feature is provided. The system includes the decorative tile. The decorative tile includes a decorative face and the grout receiving feature formed into the decorative tile. The grout receiving feature includes a recess from the decorative face.

In some embodiments, the system further includes glowing grout disposed within the grout receiving feature.

In some embodiments, the grout receiving feature includes a grout receiving groove formed in a straight line.

In some embodiments, the decorative tile further includes a plurality of oval-shaped grout receiving features.

In some embodiments, the grout receiving feature is configured for providing one of a logo, a word, a phrase, or an image upon the decorative face.

In some embodiments, the decorative tile is a planar tile.

In some embodiments, the decorative tile is a curved tile.

In some embodiments, the decorative tile is a corner tile.

In some embodiments, the grout receiving feature includes a grout retaining feature configured to create an undercut in the grout receiving feature configured to enhance grout retention.

According to one alternative embodiment, a method for forming a tile with a glowing grout receiving feature is provided. The method includes creating the tile including a decorative face and the grout receiving feature including a recess from the decorative face.

In some embodiments, the tile is created within a mold within the grout receiving feature formed therein.

In some embodiments, creating the tile includes cutting the grout receiving feature into the decorative face of the tile.

In some embodiments, the method further includes disposing grout into the grout receiving feature.

In some embodiments, the method further includes improving the grout with a luminescent additive.

In some embodiments, improving the grout includes mixing the grout while it is a liquid with the luminescent additive.

In some embodiments, improving the grout includes coating the grout with the luminescent additive.

According to one alternative embodiment, a decorative tile system with inset glowing grout is provided. The system includes the decorative tile including a decorative face and the grout receiving feature formed into the decorative tile, wherein the grout receiving feature includes a recess from the decorative face. The decorative tile further includes glowing grout disposed within the grout receiving feature.

In some embodiments, the system further includes a plurality of decorative tiles, wherein the grout receiving feature on each of the plurality of decorative tiles combine to create a decorative pattern in the plurality decorative tiles.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in perspective view an exemplary planar tile including two grout receiving grooves formed therein, in accordance with the present disclosure;

FIG. 2 schematically illustrates in side view the planar tile of FIG. 1, with glowing grout disposed within the two grout receiving grooves, in accordance with the present disclosure;

FIG. 3 schematically illustrates in perspective view the planar tile of FIG. 1, with glowing grout disposed within the two grout receiving grooves, in accordance with the present disclosure;

FIG. 4 schematically illustrates in top view an alternative embodiment of a planar tile, including a plurality of grout receiving features formed upon a planar face of the planar tile, with glowing grout filling the grout receiving features, in accordance with the present disclosure;

FIG. 5 schematically illustrates in cross-sectional view the planar tile of FIG. 4, in accordance with the present disclosure;

FIG. 6 schematically illustrates in top view an additional alternative embodiment of a planar tile, including a plurality of grout receiving grooves forming a decorative logo upon a planar face of the planar tile, with glowing grout filling the grout receiving grooves, in accordance with the present disclosure;

FIG. 7 schematically illustrates in cross-sectional view the planar tile of FIG. 6, in accordance with the present disclosure;

FIG. 8 is a flowchart illustrating a first method for creating tile including grout receiving features and glowing grout filled within the grout receiving features, in accordance with the present disclosure;

FIG. 9 is a flowchart illustrating a second method for creating tile including grout receiving features and grout filled within the grout receiving features, in accordance with the present disclosure;

FIG. 10 schematically illustrates in perspective view an additional alternative embodiment of a curved tile including grout receiving features and glowing grout filling the grout receiving features, in accordance with the present disclosure;

FIG. 11 schematically illustrates in perspective view an additional alternative embodiment of a corner tile including grout receiving features and glowing grout filling the grout receiving features, in accordance with the present disclosure;

FIG. 12 schematically illustrates in top view a tile system including a plurality of decorative tiles which, in combination, create a decorative pattern, in accordance with the present disclosure; and

FIG. 13 schematically illustrates the decorative tile of FIG. 2 in cross-section in magnified scale, illustrating an optional grout retention feature, in accordance with the present disclosure.

### DETAILED DESCRIPTION

A tile may include a grout receiving feature formed in a decorative face of the tile. The grout receiving feature may be formed in a wide variety of shapes. Glowing grout, or grout treated with luminescent materials, may be filled into the grout receiving feature. The glowing grout may be shaped while the grout is still a dense liquid such that an exposed surface of the glowing grout is coplanar or even with a surface of the tile on either side of the grout receiving feature. Once the grout dries, the tile including the glowing grout may provide a flat or consistently even surface across the decorative face of the tile and the exposed surface of the glowing grout.

Glowing grout may take different forms or include different constituent components. In one embodiment, glowing grout may include an epoxy grout with glow additives. Such an epoxy grout exhibits excellent stability and durability. Other options include cement grouts and grouts including urethane, acrylics, and hybrid mixtures may be utilized. In other embodiments, fillers and materials such as caulking including silicones or acrylics may be used. In another embodiment, premade strips of glow products may be glued or inserted into the grout receiving features of tiles disclosed herein. One embodiment of glowing grout is commercially available through Laticrete International, Inc. of Bethany, Connecticut. In another embodiment, grout may be mixed, coated, or improved with a luminescent additive such as Starlike® NIGHTVISION additive which is commercially available through LITOKOL S.p.A. of Rubiera, Italy.

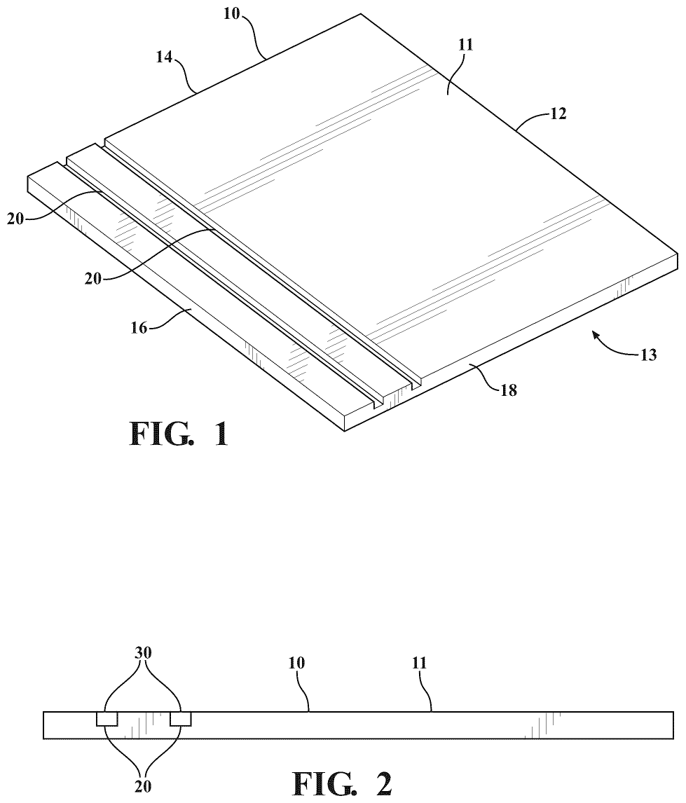

Referring now to the drawings, wherein like reference numbers refer to like features throughout the several views, FIG. 1 schematically illustrates in perspective view an exemplary decorative tile 10 including two grout receiving grooves 20 formed therein. The decorative tile 10 is illustrated including a decorative face 11, a bottom face 13, and four side surfaces 12, 14, 16, 18. The grout receiving grooves 20 are cut or otherwise formed into the decorative tile 10, each forming a recess from the decorative face 11. Each of the grout receiving grooves 20 may be described as grout receiving features and are configured for being filled with grout. The grout may be filled to be substantially level or flush with the decorative face 11. The grout may be filled to be higher than, creating a raised ridge upon, or lower than, creating a depressed trough in, the decorative face 11.

FIG. 2 schematically illustrates in side view the decorative tile 10 of FIG. 1, with glowing grout 30 disposed within the two grout receiving grooves 20. The glowing grout 30 is illustrated filled within the grout receiving grooves 20. Once the glowing grout 30 is installed and permitted to dry or cure, the decorative tile 10 and the grout installed thereto may be a stable surface upon which users may walk, arrange furniture, submerge within a swimming pool, or other uses for which tile may be utilized.

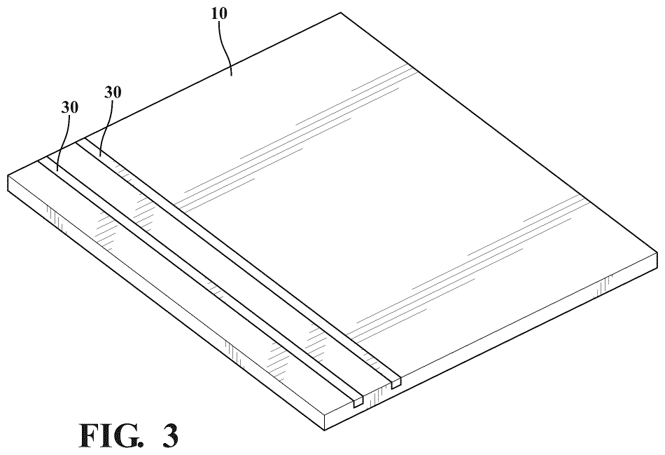

FIG. 3 schematically illustrates in perspective view the decorative tile 10 of FIG. 1, with the glowing grout 30 disposed within the two grout receiving grooves 20. The glowing grout may be luminescent, meaning that the glowing grout may include material that emits light. The decorative tile 10 may or may not also be luminescent.

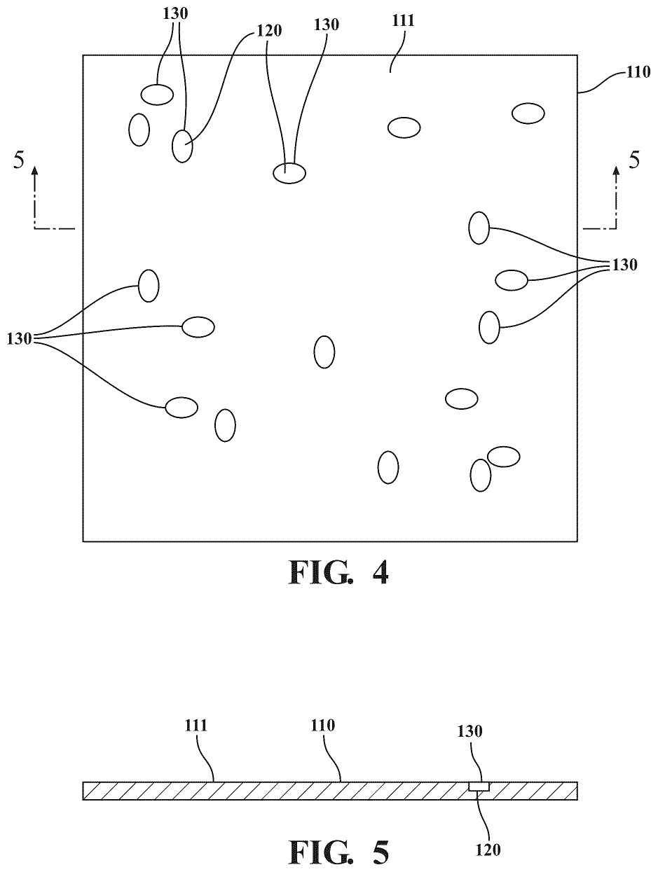

FIG. 4 schematically illustrates in top view an alternative embodiment of a planar tile 110, including a plurality of grout receiving features 120 formed upon a decorative face 111 of the planar tile 110, with glowing grout 130 filling the grout receiving features 120. The grout receiving features 120 may include various shapes configured for different visual effects upon the planar tile 110. In the example of FIG. 4, the grout receiving features 120 appear as oval shapes when viewed from above the planar tile 110, with a net effect of the grout receiving features 120 and the glowing grout 130 filled therewithin being to give an appearance of pebbles upon the planar tile 110. Cross-section 5 is defined for illustration in FIG. 5.

FIG. 5 schematically illustrates in cross-sectional view of the planar tile 110 of FIG. 4. The planar tile is illustrated including the decorative face 111, one of the grout receiving features 120, and glowing grout 130 filling the grout receiving feature 120.

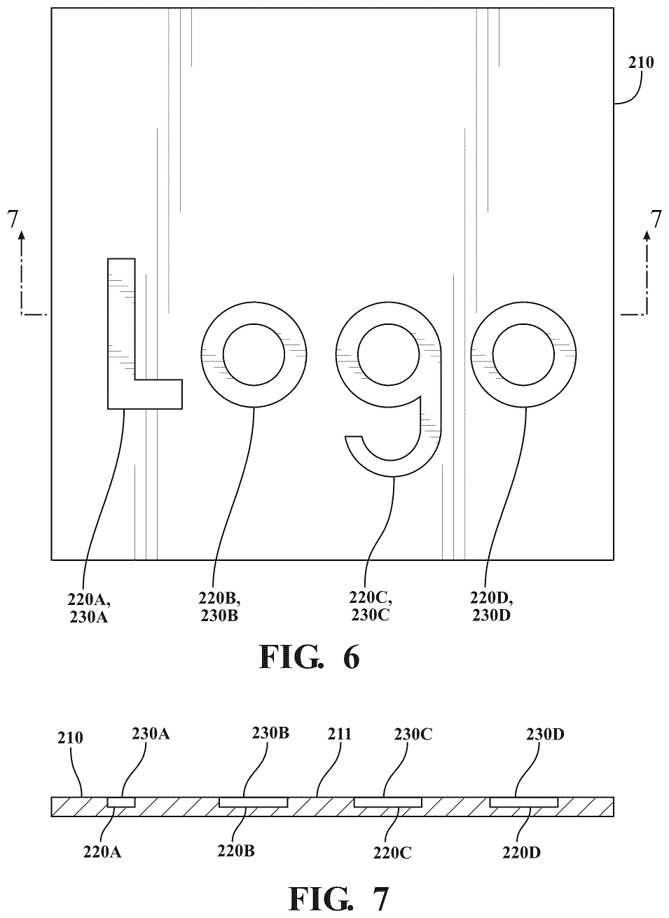

FIG. 6 schematically illustrates in top view an additional alternative embodiment of a planar tile 210, including a plurality of grout receiving features 220A, 220B, 220C, 220D forming a decorative logo upon a planar face of the planar tile, with glowing grout 230A, 230B, 230C, 230D filling the grout receiving features 220A, 220B, 220C, 220D. Cross-section 7 is defined for illustration in FIG. 7. The grout receiving features 220A, 220B, 220C, 220D and the glowing grout 230A, 230B, 230C, 230D may collectively create a logo, an image, a word or phrase, or other decorative image.

FIG. 7 schematically illustrates in cross-sectional view the planar tile 210 of FIG. 6. The planar tile 210 is illustrated including a decorative face 211, the grout receiving features 220A, 220B, 220C, 220D, and the glowing grout 230A, 230B, 230C, 230D.

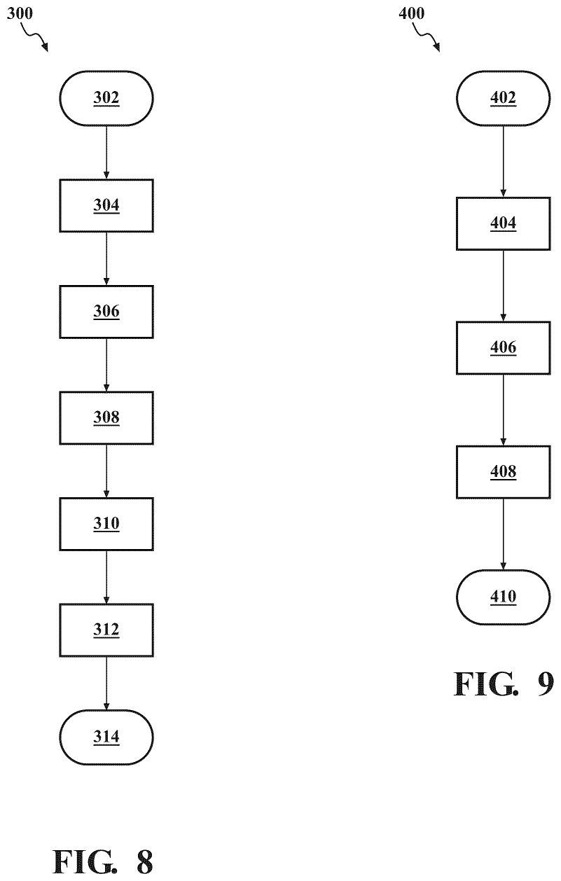

FIG. 8 is a flowchart illustrating a first method 300 for creating tile including grout receiving features and glowing grout filled within the grout receiving features. The method 300 is illustrated in relation to the decorative tile 10 of FIGS. 1-3, although the method 300 may be utilized with alternative embodiments of the disclosure. The method 300 starts at a step 302. At a step 304, a decorative pattern to be cut into a decorative face 11 of a decorative tile 10 is selected, for example, through selection in a computer aided manufacturing program with electronic instructions programmed for controlling an automated end mill device. At a step 306, a decorative tile 10 is selected and queued, and grout receiving features in a form of exemplary grout receiving grooves 20 are formed into the decorative tile 10, wherein the decorative tile 10 may have no pre-existing grout receiving features prior to the step 306. At a step 308, glowing grout 30 is dispensed or disposed within the grout receiving grooves 20. The step 308 may include drying the glowing grout 30 and cleaning excess glowing grout 30 away from the decorative face 11 of the decorative tile 10. At a step 312, the decorative tile 10 is installed for use upon a floor, wall, or other similar surface. The method 300 ends at a step 314. The method 300 is exemplary. A number of additional or alternative method steps are envisioned, and the disclosure is not intended to be limited to the examples provided herein.

FIG. 9 is a flowchart illustrating a second method 400 for creating the tile 210 including grout receiving features 220A, 220B, 220C, 220D and glowing grout 230A, 230B, 230C, 230D filled within the grout receiving features 220A, 220B, 220C, 220D. The method 400 is illustrated in relation to the planar tile 210 of FIGS. 6 and 7, although the method 400 may be utilized with alternative embodiments of the disclosure. The method 400 starts at a step 402. At a step 404, a tile mold including a decorative pattern tool feature is utilized to form a decorative tile 10 with the grout receiving features 220A, 220B, 220C, 220D. The decorative tile 10 may be permitted to dry or cure. At a step 406, glowing grout 230A, 230B, 230C, 230D is dispensed or disposed within the grout receiving grooves 220A, 220B, 220C, 220D. The step 406 may include drying the glowing grout 230A, 230B, 230C, 230D and cleaning excess glowing grout away from the decorative face 211 of the planar tile 210. At a step 408, the planar tile 210 is stacked and prepared for shipment to a customer or storage facility for later sale. The method 400 ends at a step 410. The method 400 is exemplary. A number of additional or alternative method steps are envisioned, and the disclosure is not intended to be limited to the examples provided herein.

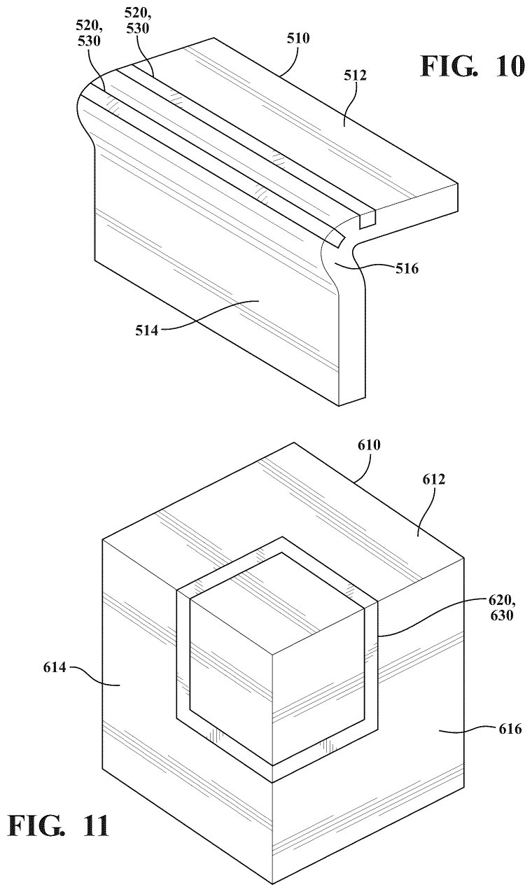

FIG. 10 schematically illustrates in perspective view an additional alternative embodiment of a curved tile 510 including grout receiving features 520 and glowing grout 530 filling the grout receiving features 520. The curved tile 510 is illustrated including an exemplary portion of a boundary for a swimming pool. The curved tile 510 may include various shapes. In the embodiment of FIG. 10, the curved tile 510 includes a first decorative face 512, a second decorative face 514, and a curved transitional portion 516. The grout receiving features 520 and the glowing grout 530 may take various shapes and forms upon the various faces of the curved tile 510.

FIG. 11 schematically illustrates in perspective view an additional alternative embodiment of a corner tile 610 including grout receiving features 620 and glowing grout 630 filling the grout receiving features 620. The corner tile 610 is illustrated including a first decorative face 612, a second decorative face 614, and a third decorative face 616. The grout receiving features 620 and the glowing grout 630 may span two or more of the decorative faces 612, 614, 616. The corner tile 610, the grout receiving features 620, and the glowing grout 630 may take many forms.

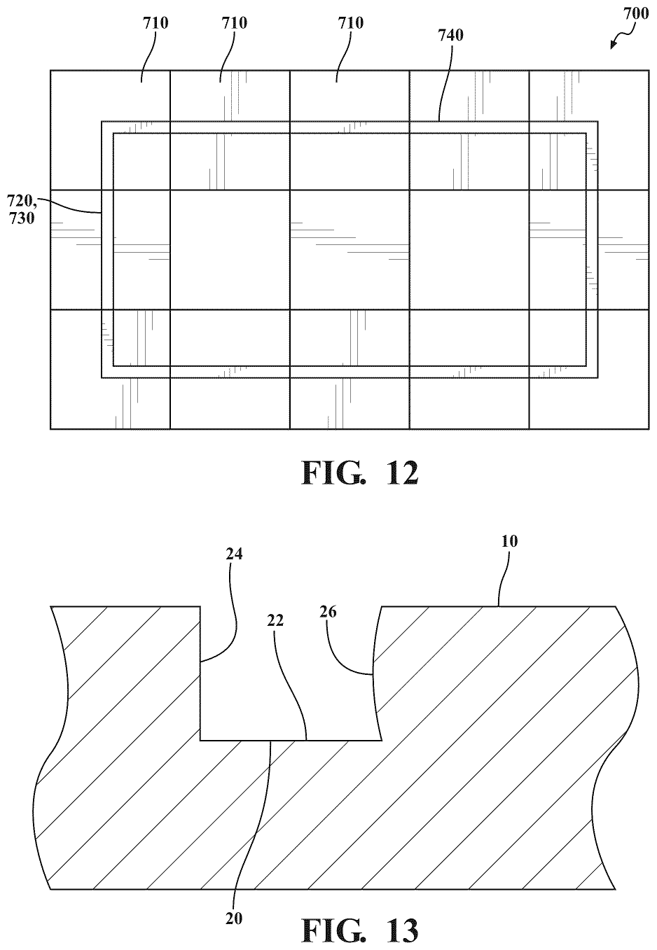

FIG. 12 schematically illustrates in top view a tile system 700 including a plurality of decorative tiles 710 which, in combination, create a decorative pattern 740. Each the decorative tiles 710 includes a grout receiving feature 720 which includes a glowing grout 730 disposed therein. The grout receiving features 720 are configured to align or coordinate with each other to create the decorative pattern 740. Decorative pattern 740 may be any desirable pattern in the plurality of decorative tiles 710, may be three dimensional, may be customizable, for example, with a family name or selected logo or trademark image formed therein. Instructions may be provided with the decorative tile 710 to instruct a person installing the decorative tiles 710.

FIG. 13 schematically illustrates the decorative tile 10 of FIG. 2 in cross-section in magnified scale. The decorative tile 10 includes the grout receiving feature 20. The grout receiving feature is illustrated including a straight side wall 24, a feature base 22, and a side wall 26 including a grout retaining feature configured to create an undercut in the grout receiving feature configured to enhance grout retention. In the embodiment of FIG. 13, the sidewall 26 includes a curved wall creating an undercut in grout disposed therein. In another embodiment, the sidewall 26 may include a slanted sidewall creating the undercut. Once grout is disposed within the grout receiving feature 20, the undercut locks the grout into place and prevents the grout from later falling out of the grout receiving feature 20.

While the best modes for carrying out the disclosure have been described in detail, those familiar with the art to which this disclosure relates will recognize various alternative designs and embodiments for practicing the disclosure within the scope of the appended claims.

What is claimed is:

1. A decorative tile with a glowing grout receiving feature, comprising:
the decorative tile, including:
a decorative face; and
the grout receiving feature formed into the decorative tile, wherein the grout receiving feature includes a recess from the decorative face.

2. The decorative tile of claim 1, further comprising glowing grout disposed within the grout receiving feature.

3. The decorative tile of claim 1, wherein the grout receiving feature includes a grout receiving groove formed in a straight line.

4. The decorative tile of claim 1, wherein the decorative tile further includes a plurality of oval-shaped grout receiving features.

5. The decorative tile of claim 1, wherein the grout receiving feature is configured for providing one of a logo, a word, a phrase, or an image upon the decorative face.

6. The decorative tile of claim 1, wherein the decorative tile is a planar tile.

7. The decorative tile of claim 1, wherein the decorative tile is a curved tile.

8. The decorative tile of claim 1, wherein the decorative tile is a corner tile.

9. The decorative tile of claim 1, wherein the grout receiving feature includes a grout retaining feature configured to create an undercut in the grout receiving feature configured to enhance grout retention.

10. A method for forming a tile with a glowing grout receiving feature, comprising:
creating the tile including a decorative face and the grout receiving feature including a recess from the decorative face.

11. The method of claim 10, wherein the tile is created within a mold with the grout receiving feature formed therein.

12. The method of claim 10, wherein creating the tile includes cutting the grout receiving feature into the decorative face of the tile.

13. The method of claim 10, further comprising disposing grout into the grout receiving feature.

14. The method of claim 13, further comprising, improving the grout with a luminescent additive.

15. The method of claim 14, wherein improving the grout includes mixing the grout while it is a liquid with the luminescent additive.

16. The method of claim 14, wherein improving the grout includes coating the grout with the luminescent additive.

17. A decorative tile system with inset glowing grout, comprising:
the decorative tile, including:
a decorative face;
the grout receiving feature formed into the decorative tile, wherein the grout receiving feature includes a recess from the decorative face; and
glowing grout disposed within the grout receiving feature.

18. The decorative tile system of claim 17, further comprising a plurality of decorative tiles, wherein the grout receiving feature on each of the plurality of decorative tiles combine to create a decorative pattern in the plurality decorative tiles.
